(19) United States
(12) Patent Application Publication
(10) Pub. No.: US 2014/0300588 A1
(43) Pub. Date: Oct. 9, 2014

(54) DRAWING DEVICE, DRAWING METHOD, AND DRAWING PROGRAM

(71) Applicant: FUNAI ELECTRIC CO., LTD., Osaka (JP)

(72) Inventor: Takeshi Nakada, Osaka (JP)

(73) Assignee: FUNAI ELECTRIC CO., LTD., Osaka (JP)

(21) Appl. No.: 14/220,232

(22) Filed: Mar. 20, 2014

(30) Foreign Application Priority Data
Apr. 8, 2013 (JP) 2013-080205

(51) Int. Cl. G06F 3/0354; G06F 3/0488

(52) U.S. Cl. CPC G06F 3/03545; G06F 3/04883
USPC 345/179

(57) ABSTRACT

A drawing device includes an input unit, an object controller, and a display controller. The input unit receives user's input. The object controller controls a display unit to display a position instruction object movable based on user's input when a line displayed on the display unit is selected. The display controller moves an end point of the selected line along the selected line based on a movement amount of the position instruction object. Further, the display controller sets a part of the selected line between end points before and after the movement as a part to be set for display deletion.

### CROSS-REFERENCE TO RELATED APPLICATIONS

This application is based on Japanese Patent Application No. 2013-080205 filed on Apr. 8, 2013, contents of which are hereby incorporated by reference.

### BACKGROUND OF THE INVENTION

1. Field of the Invention

The present invention relates to a drawing device, a drawing method, and a drawing program, for editing a displayed line.

2. Description of Related Art

Conventionally, there is known a graphic drawing system such as a CAD capable of drawing and editing graphics. In this graphic drawing system, a freehand line can be drawn using an approximation curve such as a Bezier curve. In addition, as a method for partially deleting a drawn freehand line, there are known a method of using an eraser tool for deleting a specified range as described in JP-A-2005-92256, for example, and a method of rewriting after deleting the freehand line itself once.

However, in the method of using the eraser tool for performing display deletion of the freehand line as described in JP-A-2005-92256, all the display in the specified range is deleted. Therefore, if a part to be deleted is overlapped with a part not to be deleted, the part not to be deleted is also deleted. In addition, in the method of deleting the freehand line itself once, it is necessary to operate to delete the entire line once, and further an effort should be made to rewrite the freehand line. Therefore, the display deletion of the freehand line cannot be performed easily and viscerally.

### SUMMARY OF THE INVENTION

The present invention is made in view of the above-mentioned problem, and it is an object of the present invention to provide a drawing device, a drawing method, and a drawing program, which can easily and viscerally perform display deletion of at least a part of a displayed line.

In order to achieve the above-mentioned object, a drawing device according to an aspect of the present invention includes an input unit, an object controller, and a display controller. The input unit receives user's input. When a displayed line is selected on the display unit, the object controller controls a display unit to display a position instruction object movable based on the user's input. The display controller moves an end point of the selected line along the selected line based on a movement amount of the position instruction object. In addition, the display controller sets a part of the selected line between end points before and after the movement as a part to be set for display deletion. Therefore, the user can delete at least a part of the displayed line viscerally and easily.

Further features and advantages of the present invention will be more apparent from the following description of embodiments.

### BRIEF DESCRIPTION OF THE DRAWINGS

FIG. 1 is a perspective view of an appearance of a tablet terminal.

FIG. 2 is a block diagram illustrating an internal structure of the tablet terminal.

FIG. 3 illustrates an example of a display screen when a display deletion process of a freehand line is performed using an OSD panel.

FIG. 4 is a flowchart for explaining a procedure for performing the display deletion process of a freehand line.

FIG. 5A illustrates an example of a display screen of a freehand line drawn in a first embodiment.

FIG. 5B illustrates an example of a display screen when a freehand line is selected in the first embodiment.

FIG. 5C illustrates an example of a display screen when an end point object is moved in the first embodiment.

FIG. 5D illustrates an example of a display screen when a part of the freehand line to be set for display deletion is confirmed in the first embodiment.

FIG. 5E illustrates another example of the display screen when the end point object is moved in the first embodiment.

FIG. 6A illustrates a display screen of a comparative example.

FIG. 6B illustrates a display screen when an eraser tool is selected in the comparative example.

FIG. 6C illustrates a display screen when display deletion of the freehand line is performed by the eraser tool in the comparative example.

FIG. 6D illustrates a display screen of a freehand line in which the display deletion using the eraser tool is performed in the comparative example.

FIG. 7A illustrates an example of a display screen when a freehand line is selected in a second embodiment.

FIG. 7B illustrates an example of the display screen when an end point object is moved in the second embodiment.

FIG. 7C illustrates an example of a display screen when a part of the freehand line to be set for display deletion is confirmed in the second embodiment.

FIG. 7D illustrates another example of the display screen when the end point object is moved in the second embodiment.

FIG. 8A illustrates an example of a display screen when a display deletion process of a freehand line is performed in a third embodiment.

FIG. 8B illustrates another example of the display screen when the display deletion process of a freehand line is performed in the third embodiment.

### DETAILED DESCRIPTION OF THE PREFERRED EMBODIMENTS

Now with reference to the drawings, embodiments of the present invention are described using a tablet terminal 1 as an example.

### First Embodiment

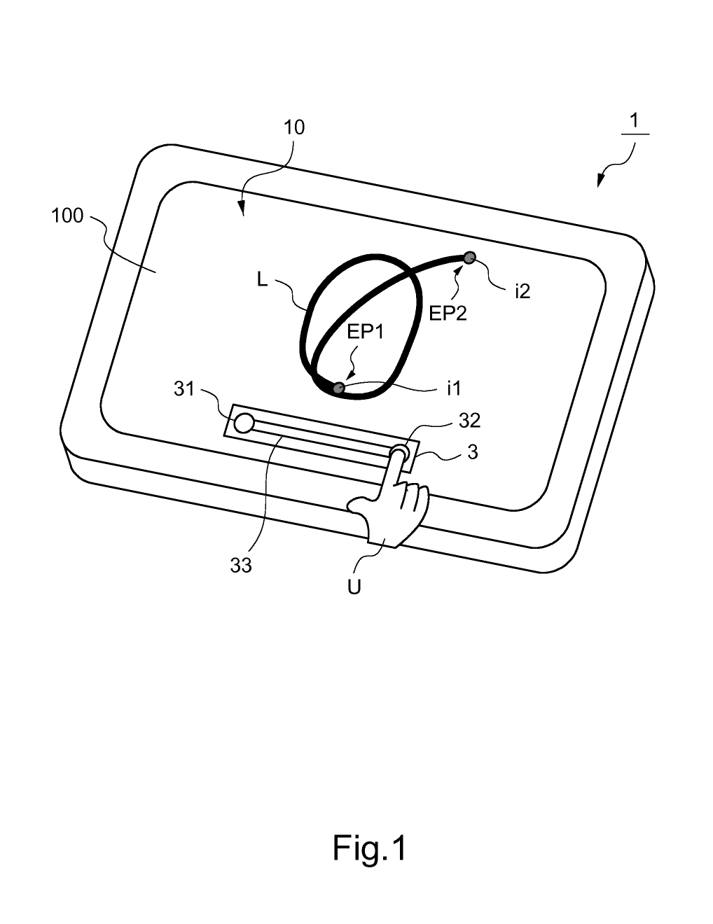

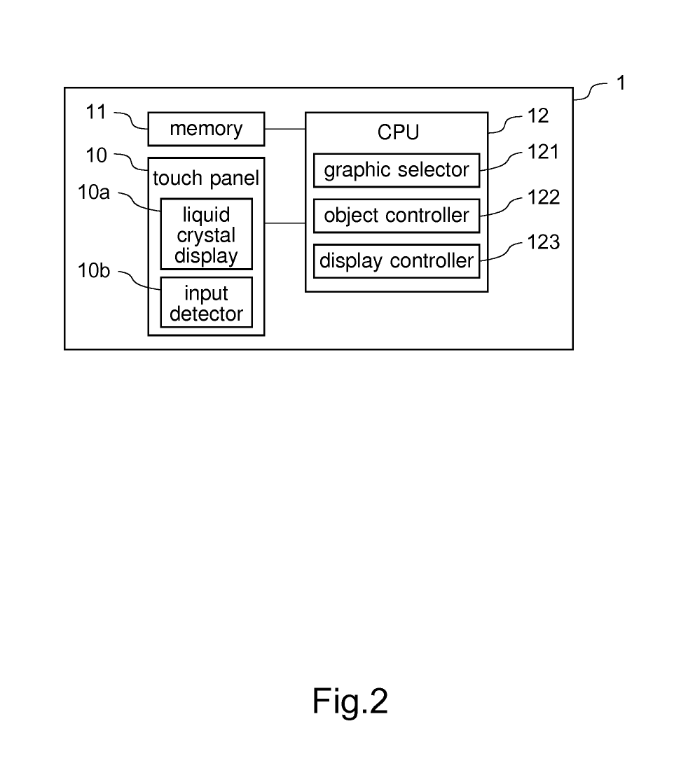

FIG. 1 is a perspective view of an appearance of the tablet terminal. FIG. 2 is a block diagram illustrating an internal structure of the tablet terminal. As illustrated in FIGS. 1 and 2, the tablet terminal 1 is a drawing device including a touch panel 10, a memory 11, and a CPU 12. Besides, the tablet terminal 1 may include a sound output unit such as a speaker for outputting sound based on a sound output signal output from the CPU 12.

The touch panel 10 is a display input unit capable of touch input when a user touches a display screen 100 with physical object U such as a finger or a touch pen. The touch panel 10 includes a liquid crystal display 10a and an input detector 10b.

The liquid crystal display 10a is a display unit for performing a display based on a control signal, an image signal, and the like output from the CPU 12. When a drawing application described later is started, the user can cause the display screen 100 of the liquid crystal display 10a to draw a freehand line L and the like by a touch input. In addition, when performing setting for deleting display of at least a part of the freehand line L (hereinafter referred to as display deletion setting), an OSD panel 3 and indicators i1 and i2 are displayed on the display screen 100. The OSD panel 3 is an object for performing an on-screen display (OSD). The OSD panel 3 includes two end point objects 31 and 32 movable based on a touch input, and a slider 33. Details of this OSD panel 3 will be described later in detail. In addition, the indicators i1 and i2 are objects for indicating positions of end points EP1 and EP2 on the freehand line L. The indicators i1 and i2 are displayed on the end points EP1 and EP2, respectively.

The input detector 10b is an input unit for receiving user's input. The input detector 10b detects an input operation by a touch input based on a movement of the physical object U (such as a user's finger or a touch pen) touching the display screen 100 of the touch panel 10. This touch input is an example of the user's input. For instance, when a user's finger U touches the display screen 100 of the touch panel 10, the input detector 10b detects a contact position on the display screen 100 touched by the finger U. Further, when the user's finger U moves (traces) on the display screen 100 while contacting with the display screen 100, the input detector 10b detects contact positions on the display screen 100 indicating a locus traced by the finger U.

The memory 11 is a nonvolatile storage medium. The memory 11 stores display information of the touch panel 10, and a program, control information, and the like used by elements (such as the CPU 12) of the tablet terminal 1. This program includes a drawing program for performing a display deletion process of the freehand line L.

The CPU 12 is a control unit for controlling elements of the tablet terminal 1. The CPU 12 uses the program, the control information, and the like stored in the memory 11 so as to perform various functions. For instance, the functional elements of the CPU 12 include a graphic selector 121, an object controller 122, and a display controller 123.

The graphic selector 121 selects a specific object based on the touch input among objects displayed on the display screen 100 of the touch panel 10. For instance, when the freehand line L displayed on the touch panel 10 is specified by the touch input, the graphic selector 121 selects the freehand line L as a target of the display deletion process.

The object controller 122 performs control of the object displayed on the touch panel 10, and particularly controls the OSD panel 3. When the freehand line L displayed on the liquid crystal display 10a of the touch panel 10 is selected by the touch input, for example, the object controller 122 controls the liquid crystal display 10a to display the OSD panel 3 and the indicators i1 and i2.

The display controller 123 controls the touch panel 10 (in particular, a display of the liquid crystal display 10a). The display controller 123 controls the liquid crystal display 10a to perform a display based on the touch input detected by the input detector 10b of the touch panel 10 and to delete a display of a part La of the freehand line L to be set for display deletion based on the touch input. In addition, when the first end point object 31 or the second end point object 32 of the OSD panel 3 is moved based on the touch input, the display controller 123 moves the end point EP1 or EP2 of the freehand line L along the freehand line L based on its movement amount. Further, the display controller 123 sets a part of the freehand line L between end points before and after the movement as the part La to be set for display deletion.

In addition, the display controller 123 controls the liquid crystal display 10a to display a line segment of the part La to be set for display deletion before the display deletion in a different state from the remaining display part Lb. After that, when the part La to be set for display deletion is confirmed by the touch input, the display controller 123 deletes the display of the part La to be set for display deletion.

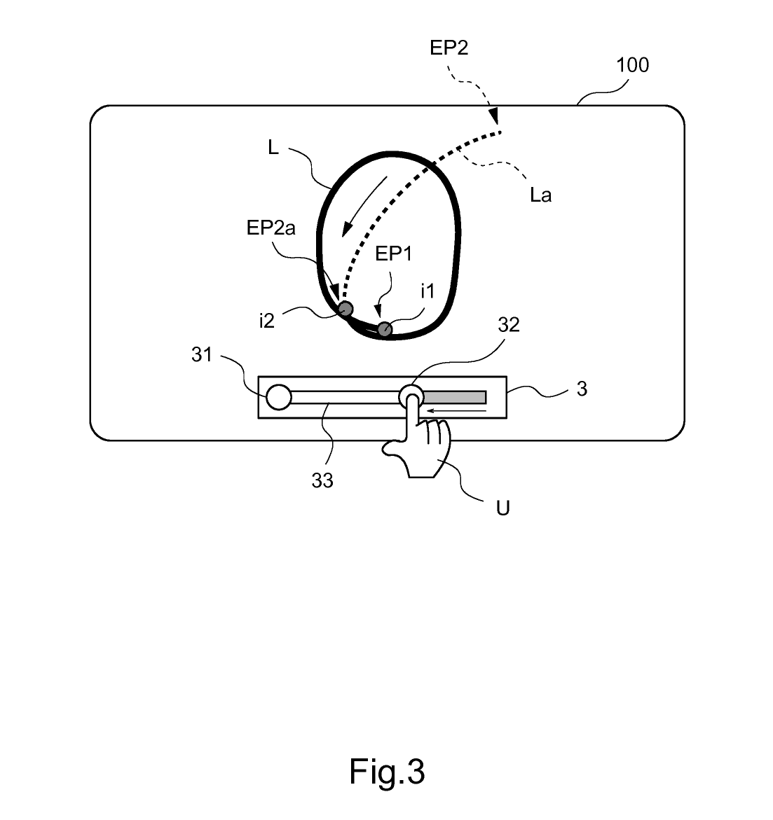

Next, there is described the OSD panel 3 that is used for performing the display deletion of the freehand line L. FIG. 3 illustrates an example of a display screen when the display deletion process of a freehand line is performed by using the OSD panel. As illustrated in FIG. 3, the OSD panel 3 displayed on the display screen 100 is an object operated by the user for instructing the part La of the freehand line L to be set for display deletion by the touch input. This OSD panel 3 includes the first and second end point objects 31 and 32 movable based on the touch input and a rod-like slider 33.

The first and second end point objects 31 and 32 are first and second position instruction objects for moving positions of the end points EP1 and EP2 of the freehand line L along the freehand line L, respectively. The first and second end point objects 31 and 32 are initially positioned at both ends of the slider 33 and can be moved along the slider 33 in accordance with the touch input. In addition, the first end point object 31 corresponds to the one end point EP1 of the freehand line L, and the second end point object 32 corresponds to the other end point EP2.

As illustrated in FIG. 3, when the second end point object 32 is moved by the touch input, the end point EP2 also moves a distance corresponding to the movement amount along the freehand line L. Then, the line segment between the end points EP2 and EP2a before and after the movement is set as the part La to be set for display deletion. Similarly, when the first end point object 31 is moved by the touch input, the end point EP1 also moves the distance corresponding to the movement amount along the freehand line L. Then, the line segment between the end points before and after the movement is set as the part La to be set for display deletion.

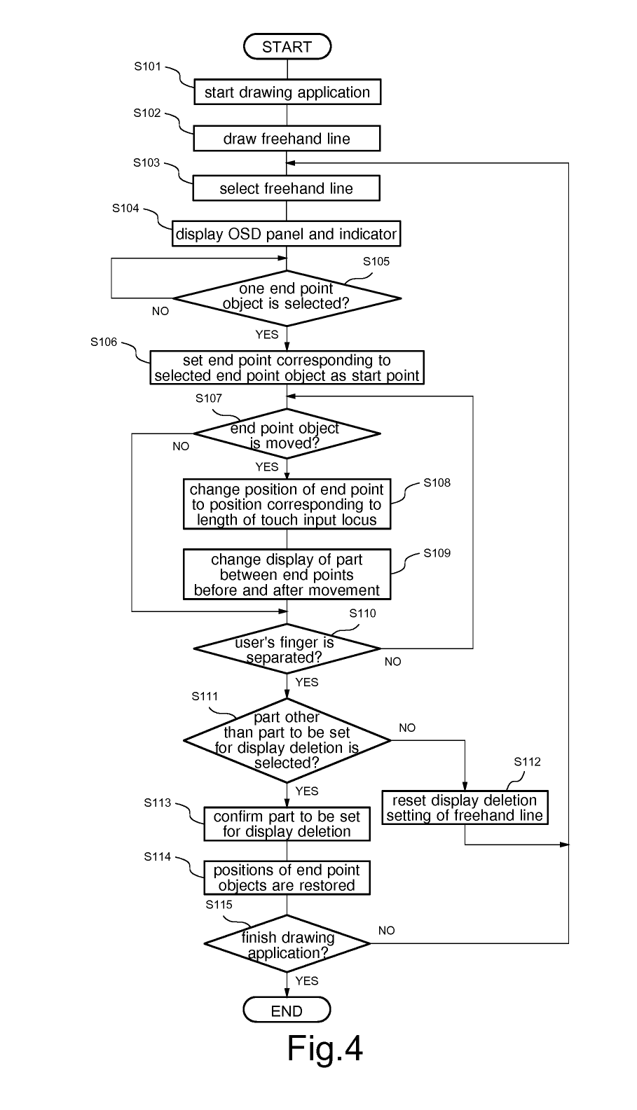

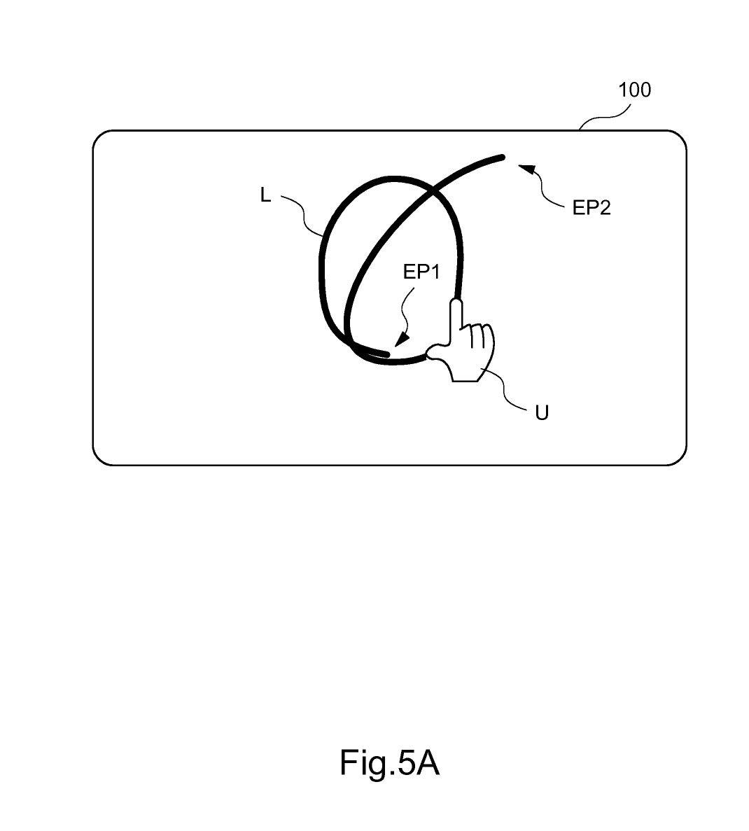

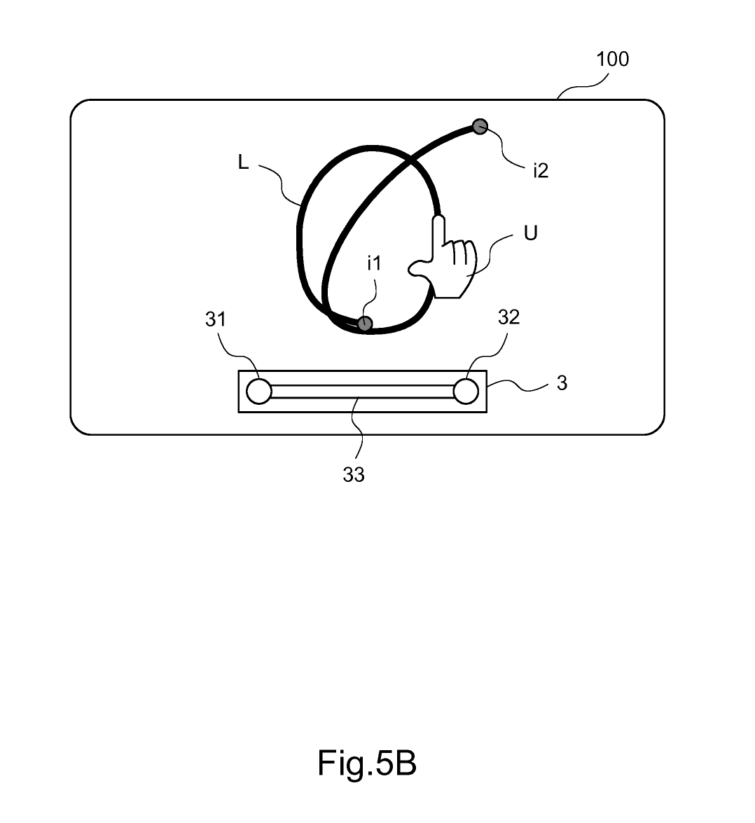

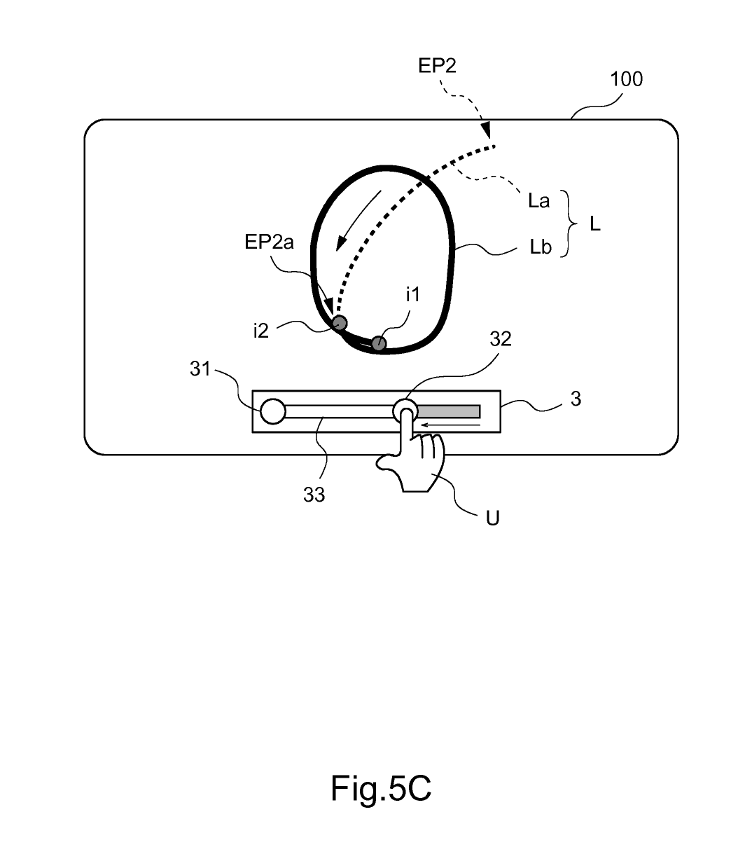

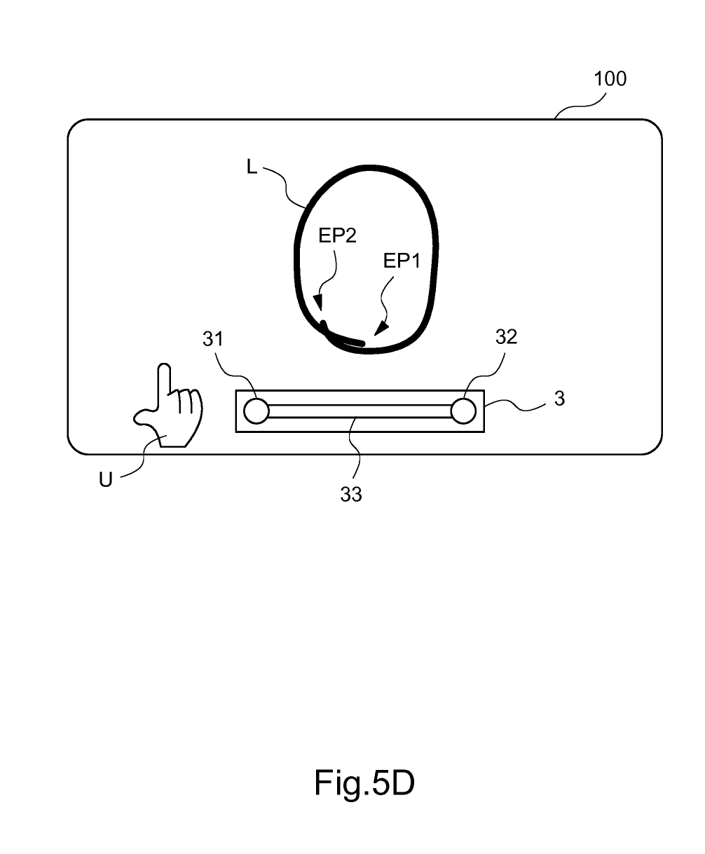

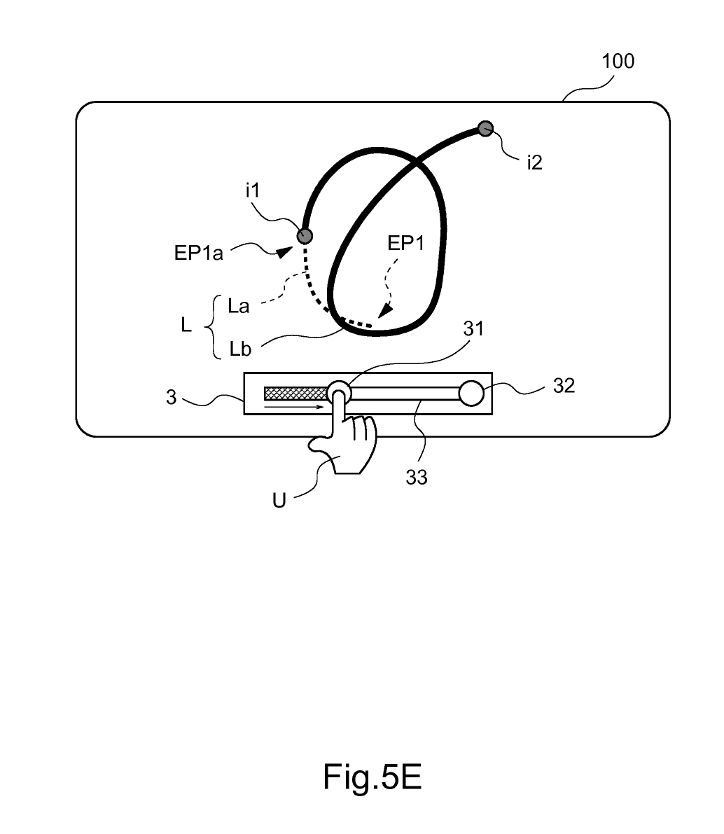

Next, there is described a drawing method when the display deletion process of the freehand line L is performed. FIG. 4 is a flowchart for explaining a procedure of the display deletion process of a freehand line. In addition, FIGS. 5A to 5E illustrate an example of the display screen 100 in each process when the display deletion process of the freehand line L is performed in the first embodiment. FIG. 5A is an example of the display screen of the freehand line drawn in the first embodiment. FIG. 5B is an example of the display screen when the freehand line is selected in the first embodiment. FIG. 5C is an example of the display screen when the end point object is moved in the first embodiment. FIG. 5D is an example of the display screen when the part of the freehand line to be set for display deletion is confirmed in the first embodiment. FIG. 5E is another example of the display screen when the end point object is moved in the first embodiment.

First, when an icon for drawing (not shown) or the like is selected by the touch input, for example, a drawing application (drawing program) is started (Step S101). Further, when the touch panel 10 is traced by the touch input with a user's finger U, the freehand line L is drawn as illustrated in FIG. 5A (Step S102). By this touch input, the freehand line L having a shape corresponding to a locus traced before the user's finger U is separated is displayed on the display screen 100.

Next, as illustrated in FIG. 5B, when the display of the freehand line L, which is already displayed by the touch input with the user's finger U, is touched, the freehand line L is selected as a target of the display deletion process (Step S103). Then, the OSD panel 3 and the indicators i1 and i2 are displayed (Step S104). In this case, the indicators i1 and i2 are displayed respectively at the end EP1 and at the end EP2 of the selected freehand line L.

When the second end point object 32 of the OSD panel 3 is selected by the touch input (YES in Step S105), the end point EP2 is set as a start point of the part La of the freehand line L to be set for display deletion (Step S106). Then, it is determined whether or not the second end point object 32 is moved on the slider 33 by the touch input (Step S107). If the second end point object 32 is not moved (No in Step S107), the process proceeds to Step S110.

If the second end point object 32 is moved (YES in Step S107), the positions of the end point EP2 and the indicator i2 are changed (Step S108). In other words, the positions of the end point EP2 and the indicator i2 are set to the position having a length along freehand line L corresponding to the locus of the touch input along the slider 33 from the start point (end point EP2 before the movement) as illustrated in FIG. 5C. Then, the line segment La of the part along the freehand line L between the positions of the end points EP2 and EP2a before and after the movement is set as the part to be set for display deletion and is displayed in a different state from the remaining display part Lb (Step S109). For instance, if the movement amount of the second end point object 32 along the slider 33 has a ⅓ length of the slider 33, the position of the end point EP2a after the movement is set to the position having a ⅓ length of the freehand line L from the end point EP2 before the movement along the freehand line L. In addition, the indicator i2 is displayed at the end point EP2a after the movement. Further, the line segment of the freehand line L between the end points EP2 and EP2a before and after the movement is set as the part La to be set for display deletion. Then the process proceeds to Step S110.

In Step S110, it is determined whether or not the user's finger U is separated from the touch panel 10. If the user's finger U is not separated (No in Step S110), the process returns to Step S107. If the user's finger U is separated (YES in Step S110), it is determined whether or not a part other than the part La to be set for display deletion is selected by the touch input in a predetermined time after the user's finger U is separated (Step S111).

If a part other than the part La to be set for display deletion is not selected (No in Step S111), the process performed in Steps S103 to S110 is reset (Step S112). In other words, the positions of the end point EP2 and the indicator i2 are reset to the positions before the movement in Step S108, and the freehand line L is reset to the state before Step S103 (see FIG. 5B). Then, the process returned to Step S103.

On the other hand, if a part other than the part La to be set for display deletion is selected (YES in Step S111), the part La to be set for display deletion is confirmed and deleted (Step S113) as illustrated in FIG. 5D. Then, the remaining display part Lb is set as a new freehand line L, and hence the positions of the first and second end point objects 31 and 32 are also reset to the initial positions (both ends of the slider 33) (Step S114).

Next, if the drawing application is not finished (No in Step S115), the process returns to S103. On the other hand, if the drawing application is finished (YES in Step S115), the process of FIG. 4 is finished.

In the method described above, the second end point object 32 is selected in Step S105, but it is possible to select the first end point object 31 as illustrated in FIG. 5E, so as to perform the same process. For instance, in accordance with the movement of the first end point object 31, positions of the end point EP1 and the indicator i1 are set to a position having a length along the freehand line L corresponding to a locus of the touch input along the slider 33 (position of an end point EP1a after the movement). In addition, the line segment of the part along the freehand line L between positions of the end points EP1 and EP1a before and after the movement is set as the part La to be set for display deletion and is displayed in a different state from the remaining display part Lb. Further, when a part other than the part La to be set for display deletion is selected, the part La to be set for display deletion is confirmed and is deleted, so that the remaining display part Lb is set as a new freehand line L. In addition, the positions of the first and second end point objects 31 and 32 are also reset respectively to the initial positions (both ends of the slider 33).

In addition, in the method described above, the part La to be set for display deletion is displayed by a broken line in Step S109 as illustrated in FIG. 5C and FIG. 5E, but the application range of the present invention is not limited to this example. It is sufficient that the part La to be set for display deletion is displayed in a different state from the remaining display part Lb. For instance, the part La to be set for display deletion may be displayed in a different type of line (a broken line, a dashed dotted line, a dotted line, or the like) from the display part Lb, or may be displayed in a different display color from the display part Lb. Alternatively, the part La to be set for display deletion may be displayed in a translucent color or may not be displayed.

### Comparative Example

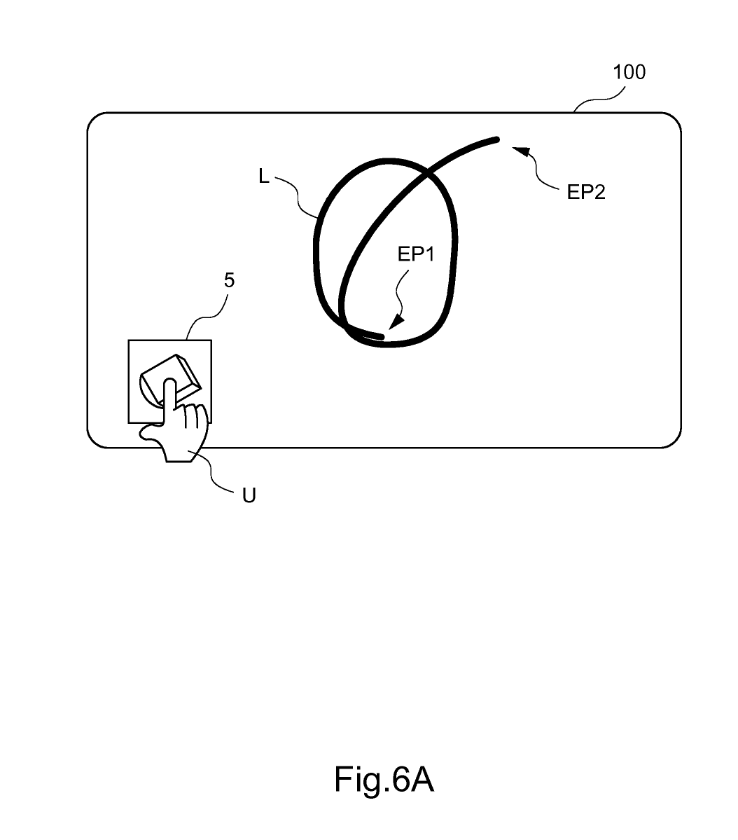

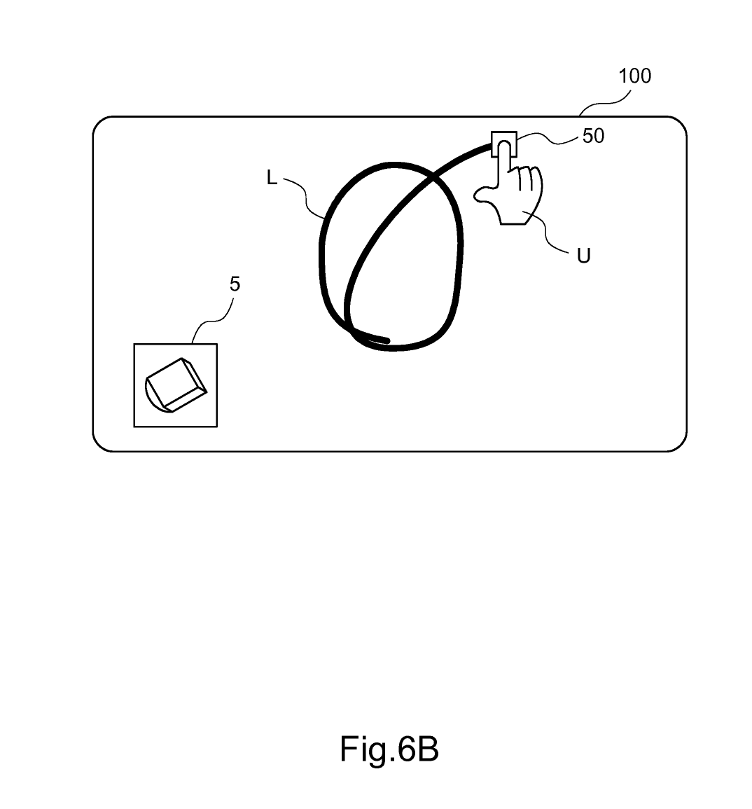

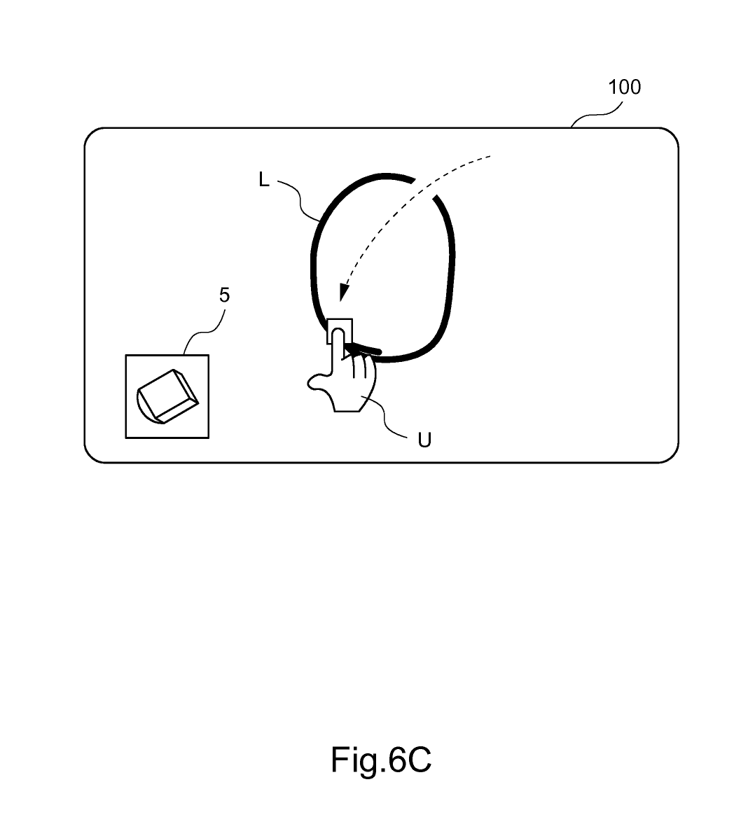

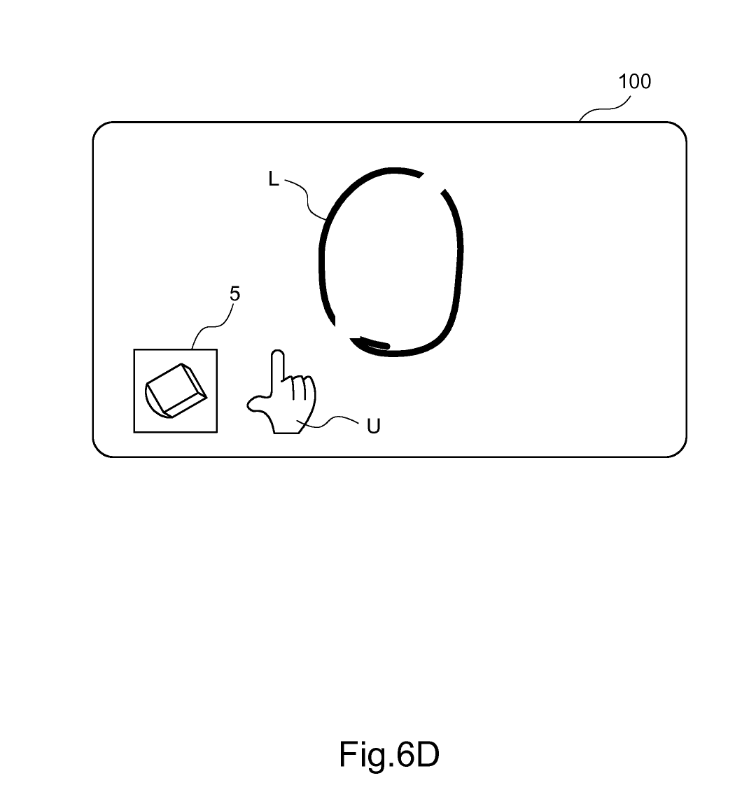

Next, in order to facilitate understanding of the effect of this embodiment, there is described a comparative example in which the display deletion process of the freehand line L is performed by a different method from the display deletion process using the OSD panel 3. In this comparative example, an eraser tool 50 is used for deleting a part of a predetermined length from the end point EP2 along the freehand line L. FIGS. 6A to 6D illustrate the display screen 100 in each process when the display deletion process of the freehand line L is performed in the comparative example. FIG. 6A illustrates a display screen of the comparative example. FIG. 6B illustrates a display screen when the eraser tool is selected in the comparative example. FIG. 6C illustrates a display screen when the display deletion of the freehand line is performed by the eraser tool in the comparative example. FIG. 6D illustrates a display screen of the freehand line after the display deletion using the eraser tool in the comparative example.

When an eraser tool icon 5 is selected by the touch input as illustrated in FIG. 6A, the eraser tool 50 is displayed on the position touched by the user's finger U on the display screen 100 as illustrated in FIG. 6B. When the tracing is performed in the state on the display screen 100, the eraser tool 50 moves in the same locus as the touch input as illustrated in FIG. 6C. Therefore, in the comparative example, the display of the region overlapping with the locus is all deleted as illustrated in FIG. 6D. Therefore, a display of a part other than the part of a predetermined length from the end point EP2 of the freehand line L is also deleted. In this way, the comparative example is different from this embodiment in that although only the part of a predetermined length from the end point EP2 is wanted to be deleted, a display of a part other than the part to be deleted may also be deleted.

As described above, the first embodiment is described. The tablet terminal 1 of the first embodiment includes the input detector 10b, the object controller 122, and the display controller 123. The input detector 10b receives the touch input. When the freehand line L displayed on the liquid crystal display 10a is selected, the object controller 122 controls the liquid crystal display 10a to display the movable first and second end point objects 31 and 32 based on the touch input. The display controller 123 moves the end point EP1 or EP2 of the freehand line L along the freehand line L based on the movement amount of the first or second end point object 31 or 32. Further, the display controller 123 sets the part of the freehand line L between end points before and after the movement as the part La to be set for display deletion.

In addition, the drawing method used by the tablet terminal 1 of the first embodiment includes the following steps. In one step, when the freehand line L displayed on the liquid crystal display 10a is selected, the first and second end point objects 31 and 32 movable based on the touch input is displayed on the liquid crystal display 10a. In addition, in one step, the end point EP1 or EP2 of the freehand line L is moved along the freehand line L based on the movement amount of the first or second end point object 31 or 32. In addition, in one step, the part of the freehand line L between end points before and after the movement is set as the part La to be set for display deletion.

In addition, the drawing program performed by the tablet terminal 1 of the first embodiment causes the CPU 12 to perform the following steps. In one step, when the freehand line L displayed on the liquid crystal display 10a is selected, the first and second end point objects 31 and 32 movable based on the touch input are displayed on the liquid crystal display 10a. In addition, in one step, the end point EP1 or EP2 of the freehand line L is moved along the freehand line L based on the movement amount of the first or second end point object 31 or 32. In addition, in one step, the part of the freehand line L between end points before and after the movement is set as the part La to be set for display deletion.

Thus, when the freehand line L displayed on the liquid crystal display 10a is selected, the first and second end point objects 31 and 32 movable based on the touch input are displayed on the liquid crystal display 10a. The end point EP1 or end point EP2 of the freehand line L is moved along the freehand line L based on the movement amount of the first end point object 31 or second end point object 32, and the part of the freehand line L between end points before and after the movement is set as the part La to be set for display deletion. Therefore, the user can viscerally and easily perform the display deletion of at least a part of the freehand line L.

Therefore, if a flick, a hook or the like is generated at the end of the freehand line L due to hand shake, for example, it is possible to easily delete the display of only the part.

In addition, in the tablet terminal 1 of the first embodiment, a length of the part La to be set for display deletion is set in accordance with the movement amount of the first end point object 31 or second end point object 32. In this way, the user can viscerally control a length of the part La to be set for display deletion.

In addition, in the tablet terminal 1 of the first embodiment, the display controller 123 controls the liquid crystal display 10a to display the part La to be set for display deletion before display deletion in a different state (for example, a display color, a type of line, or the like) from the remaining display part Lb of the freehand line L. In this way, because the part La to be set for display deletion is displayed in a different state from the remaining display part Lb, the user can viscerally recognize the part La to be set for display deletion.

In addition, the OSD panel 3 of the tablet terminal 1 of the first embodiment includes the first and second end point objects 31 and 32. The first end point object 31 is a first position instruction object for moving the one end point EP1 of the freehand line L along the freehand line L. In addition, the second end point object 32 is a second position instruction object for moving the other end point EP2 of the freehand line L along the freehand line L. In this way, the both ends of the freehand line L can be deleted as the part La to be set for display deletion.

### Second Embodiment

Next, a second embodiment of the present invention is described. In the second embodiment, the OSD panel 3 includes the first and second end point objects 31 and 32, and a circular slider 34. Other than that is the same as the first embodiment. In the following description, items different from the first embodiment are described. In addition, the same structural element as the first embodiment is denoted by the same numeral, and description thereof may be omitted.

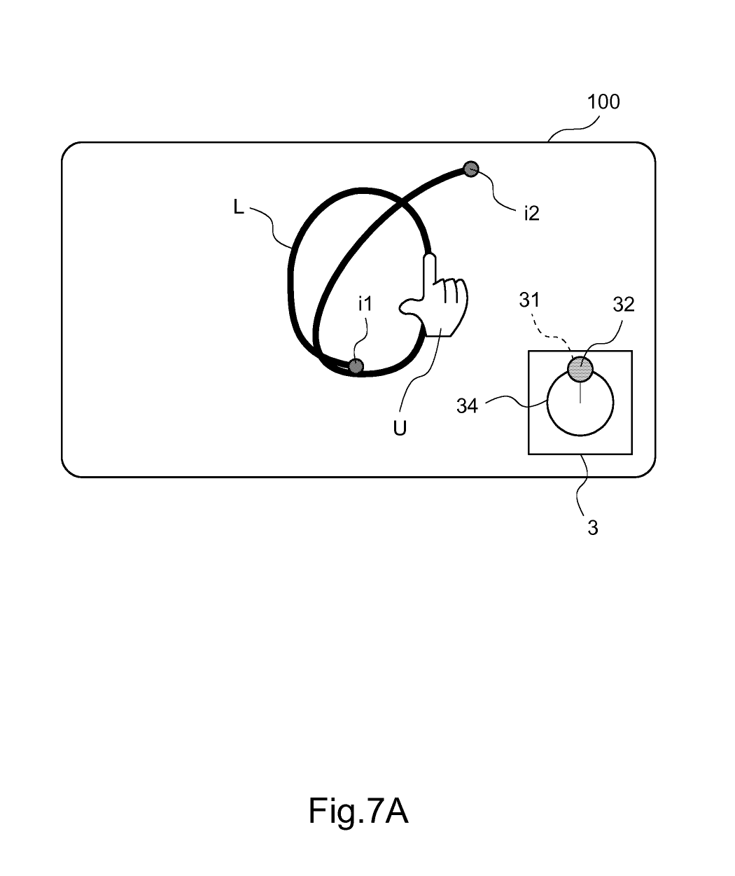

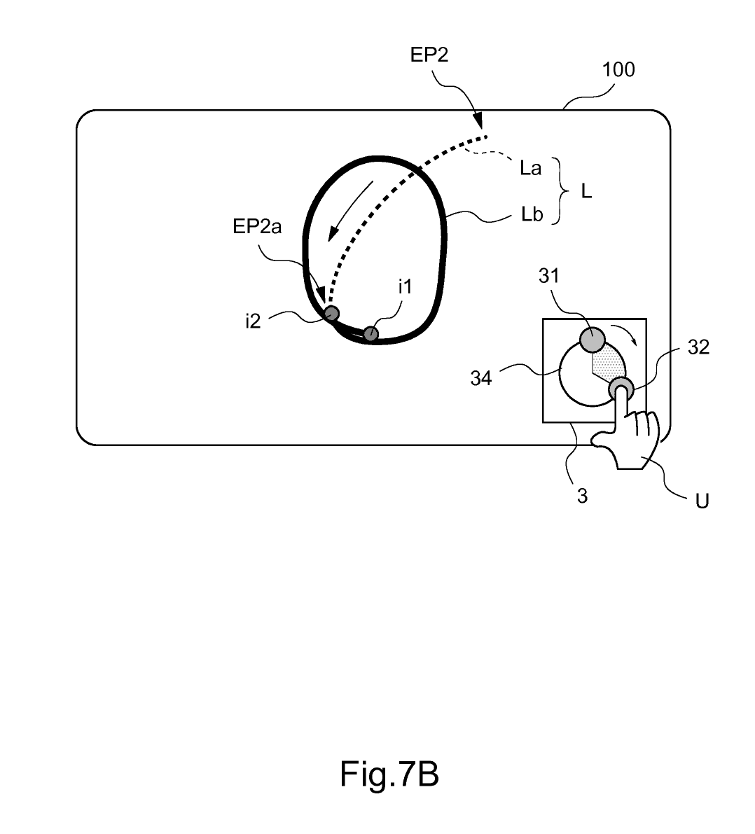

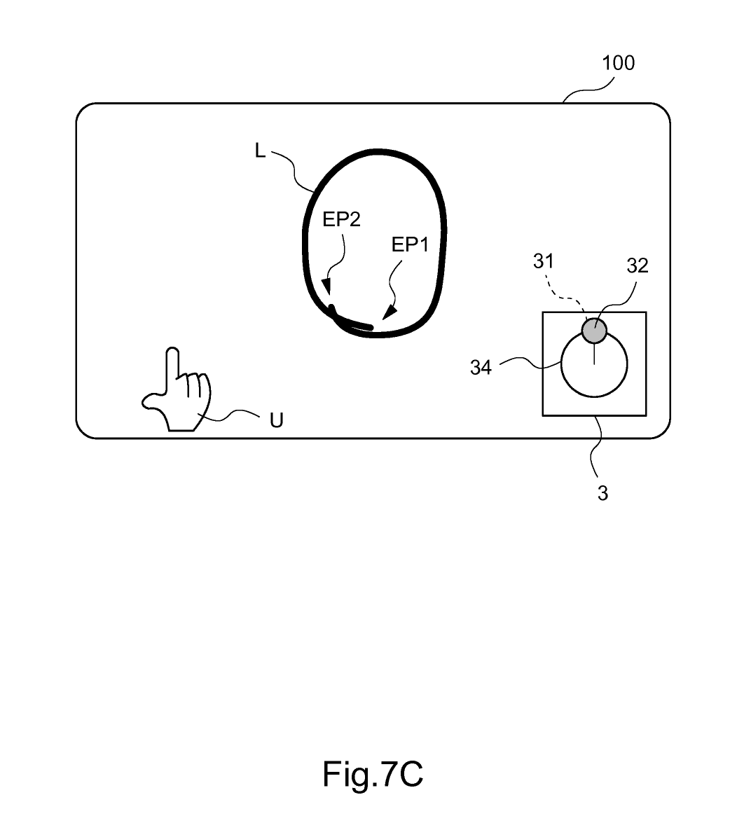

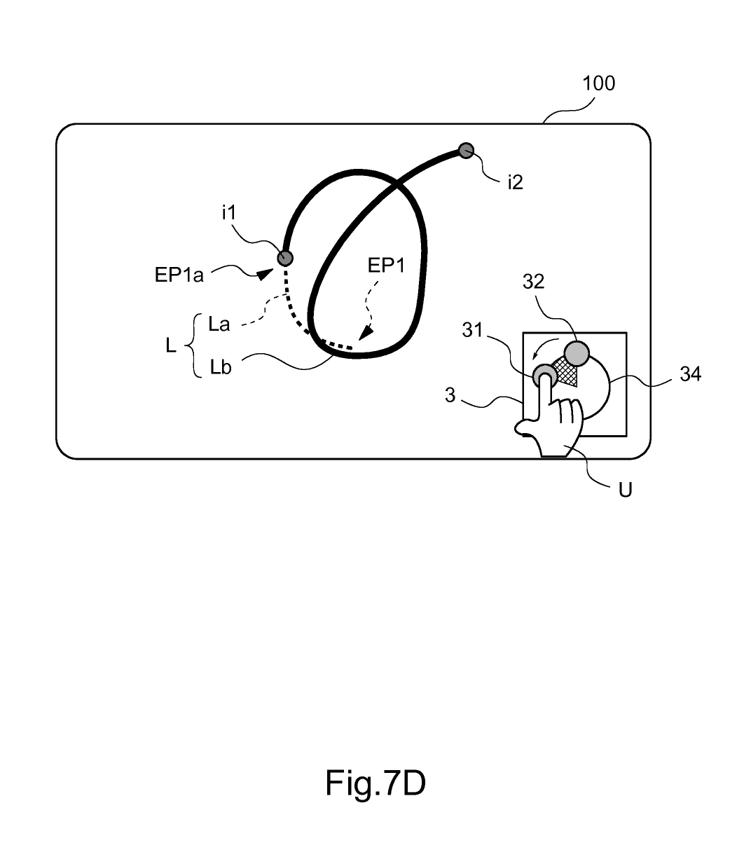

FIGS. 7A to 7E illustrate an example of the display screen 100 in each process when the display deletion process of the freehand line L is performed in the second embodiment. FIG. 7A is an example of the display screen when the freehand line is selected in the second embodiment. FIG. 7B is an example of the display screen when the end point object is moved in the second embodiment. FIG. 7C is an example of the display screen when the part of the freehand line to be set for display deletion is confirmed in the second embodiment. FIG. 7D is another example of the display screen when the end point object is moved in the second embodiment.

When the display of the freehand line L displayed on the display screen 100 is touched by the touch input with the user's finger U, the freehand line L is selected as a target of the display deletion process. Then, as illustrated in FIG. 7A, the OSD panel 3 and the indicators i1 and i2 are displayed. In this case, in the OSD panel 3, the first and second end point objects 31 and 32 are displayed and overlaid on the initial position on the circumference of the circular slider 34.

When the user's finger U touches the first and second end point objects 31 and 32 and traces in a clockwise direction along the circumference of the slider 34 as illustrated in FIG. 7B, the second end point object 32 is selected. Then, the end point EP2 is set as a start point of the part La of the freehand line L to be set for display deletion so that the positions of the end point EP2 and the indicator i2 are changed. In other words, the positions of the end point EP2 and the indicator i2 are set at the position along the freehand line L corresponding to a length of the locus of the touch input along the circumference of the slider 34. In addition, the line segment of the part along the freehand line L between positions of the end points EP2 and EP2a before and after the movement is set as the part La to be set for display deletion and is displayed in a different state from the remaining display part Lb.

For instance, if the movement amount of the second end point object 32 along the circumference of the slider 34 has a ⅓ length of the circumference of the slider 34, the position of the end point EP2a after the movement is set to the position having a ⅓ length of the freehand line L from the end point EP2 before the movement along the freehand line L. In addition, the indicator i2 is displayed at the end point EP2a after the movement. Further, the line segment of the freehand line L between the end points EP2 and EP2a before and after the movement is set as the part La to be set for display deletion and is displayed by a broken line.

Next, as illustrated in FIG. 7C, when the part other than the part La to be set for display deletion is selected by the touch input, the part La to be set for display deletion is confirmed and deleted. Then, the remaining display part Lb becomes a new freehand line L. In addition, the OSD panel 3 returns to the original display state so that the first and second end point objects 31 and 32 are displayed and overlaid on the original position on the circular circumference of the slider 34.

On the other hand, if the user's finger U traces along the circumference of the slider 34 in a counter-clockwise direction as illustrated in FIG. 7D, the first end point object 31 is selected. Then, the end point EP1 is set as a start point of the part La of the freehand line L to be set for display deletion so that the positions of the end point EP1 and the indicator i1 are changed. In other words, the positions of the end point EP1 and the indicator i1 are set to a position having a length along the freehand line L corresponding to a locus of the touch input along the circumference of the slider 34. In addition, the line segment of the part along the freehand line L between positions of the end points EP1 and EP1a before and after the movement becomes the part La to be set for display deletion and is displayed in a different state from the remaining display part Lb. Further, when a part other than the part La to be set for display deletion is selected by the touch input, the part La to be set for display deletion is confirmed and deleted. In addition, the OSD panel 3 returns to the original display state.

As described above, the second embodiment is described. In the tablet terminal 1 of the second embodiment, the OSD panel 3 includes the circular slider 34, and the first and second end point objects 31 and 32 displayed and overlaid on the circumference of the slider 34. In this way, the OSD panel 3 can be compactly displayed.

### Third Embodiment

Next, a third embodiment of the present invention is described. In the third embodiment, the first and second end point objects 31 and 32 are displayed in different specifications, and the indicators i1 and i2 are also displayed in different specifications. Other than that is the same as the first and second embodiments. In the following description, items different from the first and second embodiments are described. In addition, the same structural element as first and second embodiments is denoted by the same numeral, and description thereof may be omitted.

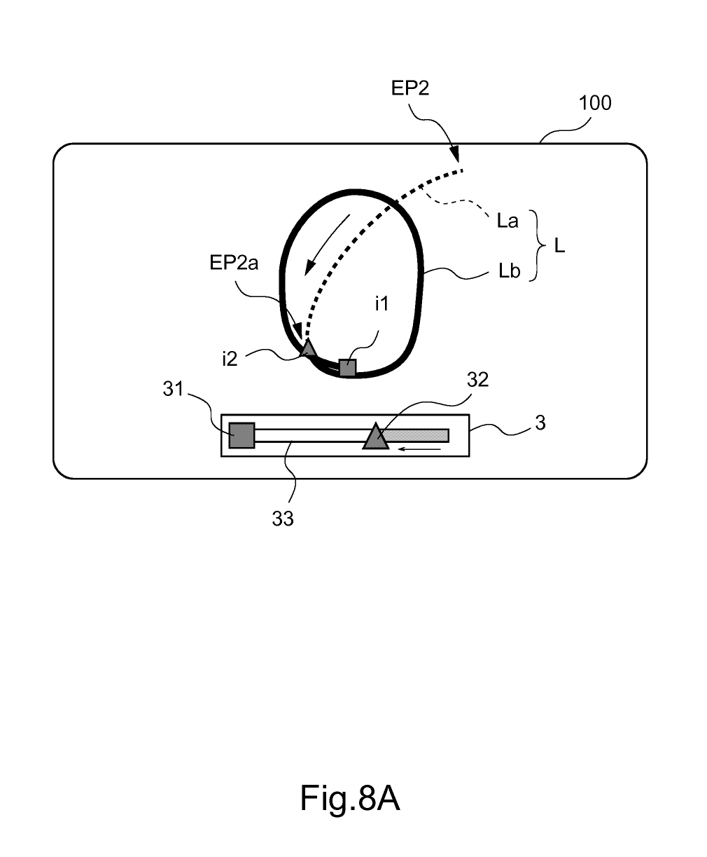

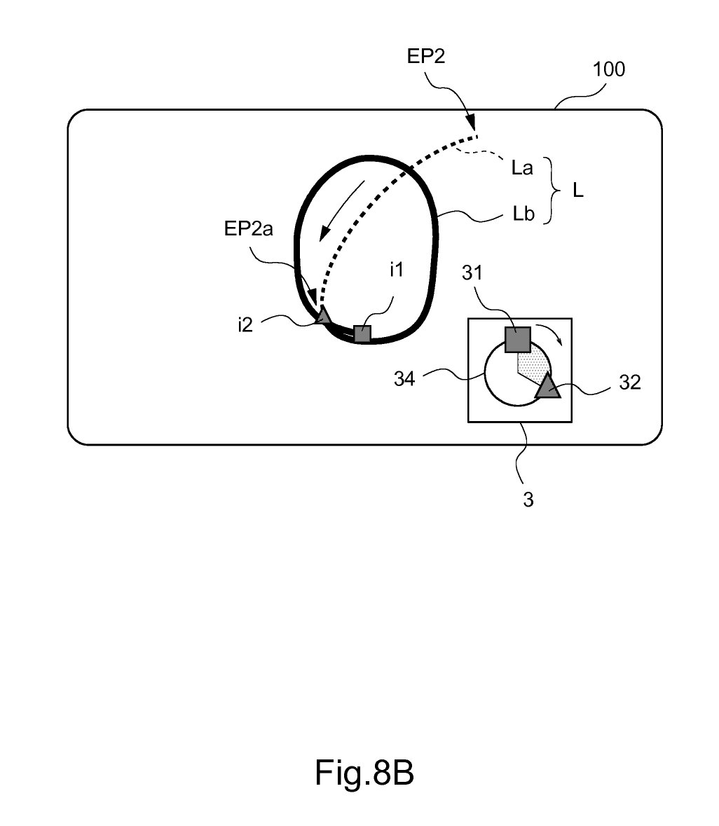

FIG. 8A illustrates an example of the display screen when the display deletion process of a freehand line is performed in the third embodiment. In addition, FIG. 8B illustrates another example of the display screen when the display deletion process of a freehand line is performed in the third embodiment. As illustrated in FIGS. 8A and 8B, the first and second end point objects 31 and 32 of the OSD panel 3 are displayed in different specifications (shapes, colors, or the like), and the indicators i1 and i2 displayed on the end points EP1 and EP2 are also displayed in different specifications (shapes, colors, or the like). On the other hand, the first end point object 31 and the indicator i1 are displayed in the same specification (shape, color, or the like), and the second end point object 32 and the indicator i2 are also displayed in the same specification (shape, color, or the like). The shapes and display colors of the first and second end point objects 31 and 32, and the indicators i1 and i2 are not limited particularly. For instance, the shapes thereof may be a polygon including a triangle, a rectangle, and a hexagon, a circle including a precise circle and an ellipse, a cross, an asterisk, or the like.

In addition, sizes of the first and second end point objects 31 and 32 may be the same as the indicators i1 and i2, but is preferably larger than the indicators i1 and i2. It is desired that the indicators i1 and i2 have sizes such that the user can easily recognize visually, but if they are too large in the display, other display such as the freehand line becomes hard to see. On the other hand, it is preferred that the first and second end point objects 31 and 32 have large sizes so that the user can easily touch for input within extent that the display is not hard to see.

As described above, the embodiments of the present invention are described. Note that the embodiments described above are examples, and elements and processes can be variously combined and modified within the scope of the present invention as easily understood by a skilled person in the art.

For instance, in the first to third embodiments described above, the graphic selector 121, the object controller 122, and the display controller 123 are realized as functional elements of the CPU 12 (an example of a computer), but the application range of the present invention is not limited to this example. These may be realized as a physical structural element different from the CPU 12 (for example, as an electric circuit or the like). Further, at least one of them may be an independent structural element.

In addition, in the first to third embodiments described above, the freehand line L is exemplified as a target of the display deletion process, but the present invention can also be applied to a display deletion process of a straight line.

In addition, in the first to third embodiments described above, the OSD panel 3 includes both the first and second end point objects 31 and 32, but the application range of the present invention is not limited to this example. It is sufficient that the OSD panel 3 includes at least one of the first and second end point objects 31 and 32. In this way, at least one of the ends of the freehand line L can be set for the part La to be set for display deletion.

In addition, in the first to third embodiments described above, the indicators i1 and i2 are displayed so that the end points EP1 and EP2 of the freehand line L can be easily recognized visually, but it is possible not to display the indicators i1 and i2.

In addition, in the first to third embodiments described above, the length of the part La to be set for display deletion is set to correspond linearly to the movement amount of the first end point object 31 or the second end point object 32 along the slider 33 or the circumference of the slider 34, but the application range of the present invention is not limited to this example. The length of the part La to be set for display deletion may be set to correspond to the movement amount non-linearly (for example, logarithmically).

In addition, in the first to third embodiments described above, when the part other than the part La to be set for display deletion is selected by the touch input, the part La is confirmed (see Step S111 and S113 in FIG. 4), but the application range of the present invention is not limited to this example. The timing when the part La to be set for display deletion is confirmed may be the timing when the part La to be set for display deletion is selected, or the timing when the user's finger U is separated from the touch panel 10 as Step S110 in FIG. 4. Alternatively, the part La to be set for display deletion may be confirmed if there is no touch input for a certain period or longer. Alternatively, the part La to be set for display deletion may be confirmed by deletion confirmation means. Such deletion confirmation means (not shown) can be realized by displaying a symbol (for example, an icon) for confirming the part La to be set for display deletion on the display screen 100.

In addition, in the first to third embodiments described above, the part La to be set for display deletion is erased when it is confirmed. The tablet terminal 1 may have a canceling function (so-called undo function) for returning to the state before the display deletion process is performed on the freehand line L after the part La to be set for display deletion is deleted. This function can be realized, for example, by displaying a symbol (so-called undo icon) for performing the canceling function on the display screen 100 of the touch panel 10. In this way, even if the display deletion of the freehand line L causes a result against user's intention, the user can restore the state before the display deletion process is performed on the freehand line L by the canceling function. Therefore, even if an unintended part is deleted due to user's misoperation, or the part La to be set for display deletion is too long or too short, it is possible to redo the display deletion process on the freehand line L.

In addition, in the first to third embodiments described above, the tablet terminal 1 including the touch panel 10 is exemplified, but the application range of the present invention is not limited to this example. The present invention can be widely applied to electronic equipment having a drawing application, such as a smart phone, a personal computer, or a PDA. In addition, the present invention can also be applied to an information processing device equipped with or connected to a display device such as a liquid crystal display and an input device such as a keyboard or a mouse instead of the touch panel 10.

What is claimed is:

1. A drawing device comprising:
an input unit for receiving user's input;
an object controller configured to control a display unit to display a position instruction object movable based on the user's input when a line displayed on the display unit is selected; and
a display controller configured to move an end point of the selected line along the selected line based on a movement amount of the position instruction object, and to set a part of the selected line between end points before and after the movement as a part to be set for display deletion.

2. The drawing device according to claim 1, wherein a length of the part to be set for display deletion is set in accordance with the movement amount of the position instruction object.

3. The drawing device according to claim 1, wherein the display controller controls the display unit to display the part to be set for display deletion before the display deletion in a different state from a remaining part of the selected line.

4. The drawing device according to claim 1, wherein the position instruction object is configured to include a first position instruction object for moving one end point of the selected line along the selected line, and a second position instruction object for moving the other end point of the selected line along the selected line.

5. A drawing method comprising the steps of:
controlling a display unit to display a position instruction object movable based on user's input when a line displayed on the display unit is selected;
moving an end point of the selected line along the selected line based on a movement amount of the position instruction object; and
setting a part of the selected line between end points before and after the movement as a part to be set for display deletion.

6. A computer-readable non-transitory recording medium storing a drawing program for causing a computer to perform the steps of:
controlling a display unit to display a position instruction object movable based on user's input when a line displayed on the display unit is selected;
moving an end point of the selected line along the selected line based on a movement amount of the position instruction object; and
setting a part of the selected line between end points before and after the movement as a part to be set for display deletion.
